(19) United States
(12) Patent Application Publication
(10) Pub. No.: US 2007/0171491 A1
(43) Pub. Date: Jul. 26, 2007

(54) Holographic or diffraction devices

(76) Inventor: Roger Bradley Millington, Cambridgeshire (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/402,709

(22) Filed: Apr. 12, 2006

Related U.S. Application Data
(63) Continuation of application No. PCT/GB05/02226, filed on Jun. 6, 2005.

(30) Foreign Application Priority Data
Jun. 8, 2004 (GB) 0412718.9
Jul. 19, 2004 (GB) 0416128.7
Oct. 22, 2004 (GB) 0423544.6

(51) Int. Cl. G03H 1/00

(52) U.S. Cl. 359/2

(57) ABSTRACT

A holographic or diffraction device responsive to interrogation, the device comprising an image-former and an image-concealer; wherein the image-former is adapted such that light reflected from or transmitted through it forms at least one image; wherein the image-concealer acts to attenuate the image; and wherein the attenuation of the image by the image-concealer is alterable responsive to interrogation.

### FIELD OF THE INVENTION

This invention relates to holographic or diffraction devices which are suitable for use in authenticating various articles and products.

### BACKGROUND TO THE INVENTION

Holographic security labels are currently manufactured in large quantities using embossed foil mass-production techniques. A variety of levels of security are provided by a combination of multiple images, image complexity, multiple colours, multiple illumination formats, messages, coded messages, overt images, covert images and label removal prevention.

Semi-transparent embossed reflection holograms, designed to overlay visible printed documentation are known. U.S. Pat. No. 5,351,142 discloses a reflection hologram comprising a transparent embossed layer with a reflectivity which is enhanced by a layer of tin tungsten oxide. U.S. Pat. No. 5,781,316 discloses a cost-effective method of making a reflection hologram comprising a transparent embossed layer with a reflectivity which is enhanced by a layer of zinc sulfide. U.S. Pat. No. 4,856,857 discloses a reflection hologram comprising a transparent embossed layer with a reflectivity which is enhanced by an overlayer of different refractive index. These methods produce embossed reflection hologram structures which produce a stable image, i.e. one which is designed not to change in visibility or appearance during normal operating conditions.

U.S. Pat. No. 5,838,466 discloses a reflection hologram comprising a transparent embossed layer with a reflectivity which is suppressed by the addition of a transparent layer which is removed by hand in order to make the holographic image visible. This device is a means of providing a covert embossed reflection hologram which can be revealed easily by manual removal of an index matching layer.

Another way of providing covert holographic images is to form the stored image so that it is read only by a focussed beam of light, as disclosed in U.S. Pat. No. 5,742,411.

Outside the field of holographic security labels but in the field of chemical sensing, several devices and methods have been described which operate by modifying the optically diffractive properties of diffraction gratings and other surface structures in order to sense the presence or concentration of chemical analytes. WO88/07273, EP0254575 and U.S. Pat. No. 5,118,608 all disclose methods of treating a diffraction grating with a polymer to which a chemical ligand has been attached so that the optical properties of the grating are altered by binding of a chemical analyte to the ligand. Optical devices of this type seek to sense small changes in intensity or colour of diffracted light in order to interpret such changes as analyte presence or concentration. They are not image-forming devices or security labels.

WO95/26499 discloses a holographic sensor. The sensor comprises a holographic support medium and, disposed throughout its volume, a hologram. The support medium interacts with an analyte, resulting in a variation of a physical property of the medium. This variation induces a change in an optical characteristic of the holographic element, such as its polarisability, reflectance, refractance or absorbance. If any change occurs whilst the hologram is being replayed (e.g. using incident broad band, non-ionising electromagnetic radiation), then a colour change, for example, may be observed using an optical detector. The optical detector may be a spectrometer or simply the human eye.

WO99/63408 describes an alternative method of producing a holographic sensor. A sequential treatment technique is used, wherein the polymer film is made first and sensitive silver halide particles are added subsequently. These particles are introduced by diffusing soluble salts into the polymer matrix where they react to form an insoluble light-sensitive precipitate. The holographic image is then recorded.

WO01/50113 describes a holographic sensor which comprises a plurality of holographic recordings. The presence or appearance of each holographic image is visible to the eye as a function of the response of the sensor to the analyte; that response may involve the appearance or disappearance, or a change in, a visible image. Typically, each image has a reflection spectrum characterised by its location in the invisible or visible spectrum of light. The location in the spectrum may be unique to each image, such that the images are separable by wavelength-selective means, and are therefore wavelength-multiplexed. During recordal, the swelling state of the support medium may be varied for each exposure, to produce images which replay at different wavelengths.

WO04/081676 describes a “silverless” holographic sensor, in which the holographic fringes are defined by different degrees of swellability in a liquid. The holographic image is recorded by selective (de)polymerisation of the support medium, wherein the medium is in a swellable state during the recording. A particular procedure involves two polymerisation steps, the first forming a sensitive polymeric matrix and the second forming, in selected parts of the matrix, a different degree or type of polymerisation, thereby forming a holographic image. The second step may involve further cross-linking of the matrix, or the formation of an interpenetrating polymer.

### SUMMARY OF THE INVENTION

The present invention is based on the realisation that sensors of the type described above may have limited utility in the field of security. It is based also on the discovery of various techniques by which holographic devices can be made more difficult to forge. In particular, the present invention provides an improved embossed reflection hologram or diffraction pattern device for application to an article or product such that a covert image can be revealed by a deliberate, chemically-specific action to remove or alter the properties of an index-matching layer in order to test the authenticity of the holographic device and/or that of the article or product to which it is attached.

According to a first aspect of the invention, in a hologram or diffraction pattern device adapted to display an image alterable by an interrogator, the device comprises an image-former and an image-concealer; wherein the image-former is adapted such that light reflected from or transmitted through the image-former forms at least one holographic or diffraction image; wherein the image-concealer acts to attenuate the holographic image; and wherein the action of the interrogator is to alter the attenuation of the holographic or diffraction image by the image-concealer.

According to a second aspect of the invention, a hologram or diffraction pattern device comprises a relief pattern in one surface of a first sheet of material (which may be termed an image-former) such that reflected light forms one or more holographic or diffraction images, and a layer of chemically-sensitive material applied to the relief pattern which combines the properties of hiding the holographic or diffraction image formed by the relief pattern with those properties which render the layer susceptible to degradation by one or more specific chemical reagents.

A third aspect of the invention is a holographic device comprising a medium and, disposed therein, a hologram, wherein the medium comprises a birefringent material in which the hologram is recorded.

Another aspect of the invention is a method of verifying the authenticity of a holographic or diffraction device, the device providing a holographic or diffraction image which changes in response to interrogating by a specific interrogation means, the method comprising the steps of:

applying the specific interrogation means to the device;

viewing the image; and

establishing whether the resulting image is consistent with an authentic device.

A further aspect is a method of verifying the authenticity of a product, the product having a holographic or diffraction device thereon, the device providing a holographic or diffraction image which changes in response to interrogation by a specific interrogation means, the method comprising the steps of:

applying the specific interrogation means to the device;

viewing the image; and

establishing whether the resulting image is consistent with a device previously applied to the authentic product.

Yet another aspect of the invention is a method for concealing or revealing a holographic or diffraction image, comprising the steps of;

applying an image-concealer to attenuate the holographic or diffraction image formed by an image-former; and

interrogating the image-concealer using an interrogation means to vary the attenuation of the image and thereby conceal or reveal the image.

A yet further aspect of the invention is a method of production of a holographic device, which comprises the recording of a hologram by selective (de)polymerisation of a polymeric medium, wherein the medium is in a swellable state during the recording, and wherein the degree of exposure is varied across the medium during the recording.

Yet another aspect of the present invention is based on the discovery that, by contracting the support medium when the holographic image is recorded, the replay wavelength and, in turn, the sensitivity of the resulting sensor is increased. Accordingly, a method of production of a holographic sensor comprises:
(a) disposing within a contractable or expandable holographic support medium a holographic recording material;
(b) contracting or expanding the medium; and
(c) recording a holographic image in the contracted or expanded medium;

wherein the recording material is disposed in the medium prior to its contraction or expansion.

Controlling the degree of contraction or expansion of the medium during the recording process allows the replay wavelength and, in turn, the sensitivity of the resulting sensor to be accurately controlled. Sensors produced in this way may be used for the detection of an analyte or in security/authentication.

### DESCRIPTION OF PREFERRED EMBODIMENTS

The present invention provides an improved embossed reflection holographic device which can be used to test the authenticity of the device or an article to which it is attached. The device may be embossed.

In alternative embodiments, the first sheet of material may comprise a volume distribution of complex index of refraction which forms one or more visible images in reflection, as well as or instead of a relief pattern, or there may be also be provided a second sheet of material underlying the first sheet of material comprising a volume distribution of complex index of refraction which forms one or more visible images in reflection or transmission.

The first sheet of material may be opaque. Alternatively, the first sheet of material may be optically transparent and have a refractive index which is similar to that of the layer of chemically-sensitive material. The first sheet of material may contain within its volume a distribution of complex index of refraction which forms one or more holographic or diffraction images.

The layer of chemically-sensitive material may be opaque. Alternatively, the layer of chemically-sensitive material may be optically transparent and have a refractive index which is similar to that of the first sheet of material.

The layer of chemically-sensitive material may be composed in whole or in part of one or more substrates to one or more enzymes, or of one or more materials which can be dissolved by one or more solvents.

Preferably, the image formation means comprises a relief surface such that when light reflects from the relief surface, the reflected light forms an image. The relief surface may be opaque.

Preferably, the image concealment means comprises a layer of material, the optical properties of which act to attenuate the or each image. The interrogation means preferably comprises a chemical reagent which acts specifically on the image concealment means.

The interrogator may act to alter the optical properties of the image concealment means, e.g. it may act to remove some or all of the image concealment means.

The image concealment means may comprise a substrate of an enzyme, or may comprise material which can be dissolved by a solvent. The means may be in contact with the relief surface of the image formation means and have a refractive index similar to the refractive index of the relief surface of the image formation means. The optical properties of the image concealment means which are altered by the chemical reagents may comprise the refractive index of all or part of the image concealment means. The means may be positioned such that light reflected from or incident on the image formation means passes through it. The absorption of light by the image concealment means may act to attenuate the or each image; wherein the absorption of light by the image concealment means is altered by the action of the interrogation means. The scattering of light by the image concealment means may act to attenuate the or each image; wherein the scattering of light by the image concealment means is altered by the action of the interrogation means.

The image formation means may alternatively or further comprise a volume distribution of complex index of refraction which forms one or more visible images in reflection. The means may comprise a plurality of layers wherein the top layer comprises the relief surface and wherein an underlying layer comprises a volume distribution of complex index of refraction which forms one or more visible images in reflection or transmission.

A preferred embodiment of the invention may thus be a device comprising one or more covert holograms or a combination of covert and overt security holograms which are designed to be interrogated by specific chemicals in order to indicate authenticity of a product to which the device is attached or, in the absence of a positive response, to indicate that the product may be a fake. The procedure provides, in addition, an indicator of authenticity of the holographic device itself. In such a device, a reflection hologram may be created in the form of a contoured, or relief, surface without any metal coating, the reflectivity being due to the difference in refractive index between the contoured material and its immediate environment. During manufacture, the holographic image may then be rendered invisible by application over the relief surface of a transparent layer which has a similar refractive index to that of the hologram. The material of the layer is preferably chosen to be able to be degraded, removed or have its refractive index altered by the action of a specific chemical or specific mixture of chemicals. The image revealed may advantageously be difficult to copy or counterfeit and is therefore of security value in itself.

In alternative embodiments, diffraction images rather than holograms may be generated.

Following the foregoing description, it will be apparent to the skilled person that the invention envisages a range of possible embodiments. In terms of principles of operation, these include the following.

The image-former may comprise a holographic or diffraction device of any kind. For example, it may comprise a surface relief element, such as an embossed surface, or a volume element, such as a phase hologram or an absorption hologram, or may comprise both surface relief and volume elements, for example for producing different images.

If a surface relief element is to be used to generate a covert image, it may be combined with an image-concealer either for matching the refractive index of the surface relief element, to suppress reflection, or comprising an opaque or scattering layer for obscuring the image.

If a volume element is to be used to generate a covert image, it may be combined with an image-concealer either comprising an opaque or scattering layer for obscuring the image, or comprising a colour filtering function if the image is coloured, again for obscuring the image. Where a colour filtering function is used, interrogation would either alter the colour of the filter or remove the filter.

If a surface relief element is to be used to generate an overt image, while for example the device also comprises a volume element to form a covert image, the image-concealer may comprise a colour filtering function.

If a volume element is to be used to generate an overt image, while for example the device also comprises a surface relief element to form a covert image, the image-concealer may be transparent and may match the refractive index of the surface relief element.

Where a refractive index matching technique or a colour filtration technique is used to hide or reveal an image, it should be noted that the application of a corresponding interrogation technique may either reveal the image, which was previously hidden by the image-concealer, or hide the image, which was previously not hidden by the image-concealer. An example might be if a refractive-index-matching image-concealer covers a surface relief image-former, in which the refractive index of the image-concealer matches that of the image-former, to hide the image, only when an interrogation means is applied.

As described above, an interrogation means may comprise any means for modifying, altering or removing an image-concealer so as to reveal or hide an image. Examples include water, detergents, the application of heating or cooling (for example to change the refractive index of a material), solvents, enzymes, acids or bases.

In a further embodiment, an image-concealer may obscure only part of the area of an underlying image-former.

A hologram of the invention may be recorded in a birefringent support medium. Without wishing to be bound by theory, it is believed that it is virtually impossible to forge such a hologram. This is because, during “copying”, the light reflected from the original hologram has a different polarisation state to that hitting the recording material. This results in a faulty copy, since a hologram cannot be formed using light of different polarisation states. Holograms of this type can be formed by incorporating, for example by polymerisation, liquid crystal or optically active groups (e.g. L-cysteine) in the holographic support medium. The hologram can be viewed using, for example, a polarising filter, the image appearing then disappearing as the polarisation of reflected light is changed by the medium.

The invention is also concerned with techniques for producing holograms having a colour gradient. It has been discovered that when the “silverless” polymerisation method is used, the replay wavelength of the resulting image is dependent on the exposure time during recording. This effect is particularly pronounced for images formed by selective (de)polymerisation using a free radical inhibitor. It follows that, if the degree of exposure is varied across the recording medium, the resulting hologram replays at a plurality of wavelengths. The degree of exposure can be varied, for example, using a grey-scale mask. This methodology is much simpler than conventional techniques, as the support medium does not have to be expanded or contracted for each exposure. The invention thus provides a simple yet viable means of producing a hologram having a complex colour gradient, such a gradient being virtually impossible to forge.

There are two primary techniques that may be used, to create improved security with volume holograms. The first involves the use of multiple colours and/or colour gradients within the holographic image, to make forgery much more difficult. The second approach uses sensor holograms with specific sensitivieties, allowing images to appear or disappear when the sensor is interrogated with a specific stimulus or set of stimuli. An array of these sensor holograms can also be used to enhance the security features. A combination of these two techniques can create volume holograms which are very difficult to forge.

For the first technique, holograms with different colour images or a gradient of colour images are produced by controlling the swelling state of the polymer material during the recording process. This can be achieved by pre-swelling/pre-contracting the polymer in different solvents, moisture, heat, pressure or chemicals before recording the hologram. This can also be achieved by chemically and selectively hardening or softening areas of the polymer. The extent of the swelling of the polymer will determine the replay of colour of the holographic image when the hologram is dry. Both systems can also be used to create a swelling gradient, to produce a gradient of colours in the holographic image. Using the multiple colours and/or a gradient of colours will make it near impossible to forge the hologram using a single laser and very difficult to forge even with multiple lasers of differing frequencies. Images of different colours can also be superimposed onto one another by recording them at different swelling states of the polymer which would also make forgery very difficult. This system can also be used to create images which appear or disappear when the polymer is in a specific swelling state, adding to the security features.

In the second technique, smart polymers sensitive to specific stimuli are used as the recording material for the holograms. Using the first technique, multi-coloured images can be recorded with the smart polymer and they can be made to change, appear or disappear when the polymer is subjected to a specific stimulus which the smart polymer responds to. Regular variation of the smart polymer used in the recording process and the use of an array of different smart polymers can further add to the security features of this system.

The holographic effect may be exhibited by illumination (e.g. under white light, UV or infra-red radiation), specific temperature, magnetic or pressure conditions, or particular chemical, biochemical or biological stimuli. The hologram may be an image of an object or a 2- or 3-dimensional effect, and may be in the form of a pattern which is only visible under magnification.

Holograms of the invention may be used to authenticate an article. The hologram may be applied to an article using a transferable holographic film which is, for example, provided on a hot stamping tape. The article may be a transaction card, banknote, passport, identification card, smart card, driving licence, share certificate, bond, cheque, cheque card, tax banderole, gift voucher, postage stamp, rail or air ticket, telephone card, lottery card, event ticket, credit or debit card, business card, or an item used in consumer, brand and product protection for the purpose of distinguishing genuine products from counterfeit products and identifying stolen products. The holograms may be used to provide product and pack information for intelligent packaging applications. “Intelligent packaging” refers to a system that comprises part of, or an attachment to, a container, wrapper or enclosure, to monitor, indicate or test product information or quality or environmental conditions that will affect product quality, shelf life or safety and typical applications, such as indicators showing time-temperature, freshness, moisture, alcohol, gas, physical damage and the like. The article may be a tramper-proof label or seal.

Alternatively, the holograms can be applied to products with a decorative element or application such as any industrial or handicraft item, including but not limited to items of jewelry, items of clothing (including footwear), fabric, furniture, toys, gifts, household items (including crockery and glassware), architecture (including glass, tile, paint, metals, bricks, ceramics, wood, plastics and other internal and external installations), art (including pictures, sculpture, pottery and light installations), stationery (including greetings cards, letterheads and promotional material) and sporting goods.

The invention is particularly relevant to holographic sensors.

A holographic sensor of the type used in this invention generally comprises a support medium and, disposed throughout the volume of the medium, a hologram. The support medium interacts with an analyte resulting in a variation of a physical property of the medium. This variation induces a change in an optical characteristic of the holographic element, such as its polarisability, reflectance, refractance or absorbance. If any change occurs whilst the hologram is being replayed by incident broad band, non-ionising electromagnetic radiation, then a colour change may be observed.

There are a number of basic ways to change a physical property, and thus vary an optical characteristic. The physical property that varies is preferably the size of the holographic element. This variation may be achieved by incorporating specific groups into the support matrix, where these groups undergo a conformational change upon interaction with the analyte, and cause an expansion or contraction of the support medium. Such a group is preferably the specific binding conjugate of an analyte species. Another way of changing the physical property to change the active water content of the support medium.

A holographic sensor may be used for detection of a variety of analytes, simply by modifying the composition of the support medium. The medium preferably comprises a polymer matrix, the composition of which must be optimised to obtain a high quality film, i.e. a film having a uniform matrix in which holographic fringes can be formed. The matrix may be formed from the copolymerisation of, say, (meth)acrylamide and/or (meth)acrylate-derived monomers, and may be cross-linked. In particular, the monomer HEMA (hydroxyethyl methacrylate) is readily polymerisable and cross-linkable. PolyHEMA is a versatile support material since it is swellable, hydrophilic and widely biocompatible. Other materials suitable for use in the invention are described in WO95/26499 and WO99/63408, the contents of which are incorporated herein by reference. A “smart” polymer is preferred i.e. a material that responds to the presence of one or more specific analytes in its environment by, say, a change in volume. The sensor may be prepared according to the methods described in WO95/26499, WO99/63408 and WO04/081676.

The property of the holographic element which varies may be its charge density, volume, shape, density, viscosity, strength, hardness, charge, hydrophobicity, swellability, integrity, cross-link density or any other physical property. Variation of the or each physical property, in turn, causes a variation of an optical characteristic, such as polarisability, reflectance, refractance or absorbance of the holographic element.

The interaction can be detected remotely, using non-ionising radiation. The extent of interaction between the holographic medium and the analyte species is reflected in the degree of change of the physical property, which is detected as a variation in an optical characteristic, preferably a shift in wavelength of non-ionising radiation.

Controlling the degree of contraction or expansion of the medium during the recording process allows the replay wavelength and, in turn, the sensitivity of the resulting sensor to be accurately controlled. A holographic sensor having a controlled sensitivity can be produced by disposing within a contractable or expandable holographic support medium a holographic recording material; contracting or expanding the medium; and recording a holographic image in the contracted or expanded medium; wherein the recording material is disposed in the medium prior to its contraction or expansion. Contraction or expansion of the support medium may be achieved by immersing the medium in a suitable liquid during the recording process. For the purposes of illustration only, an acrylamide-based support medium can be contracted using a solution of NaNO₃ or ethanol. In this case, the replay wavelength and sensitivity of the resulting sensor may be accurately controlled by controlling the concentration of the solution.

Holographic sensors may be used in a test strip, chip, cartridge, swab, tube, pipette or any form of liquid sampling or testing device, and products or processes relating to human or veterinary prognostics, theranostics, diagnostics or medicines. The sensors may be used in a contact lens, sub-conjuctival implant, sub-dermal implant, test strip, chip, cartridge, swab, tube, breathalyzer, catheter, any form or blood, urine or body fluid sampling or analysis device. Holographic sensors may also be used in a product or process relating to petrochemical and chemical analysis and testing, for example in a testing device such as a test strip, chip, cartridge, swab, tube, pipette or any form of liquid sampling or analysis device.

Contraction or expansion of the support medium may be achieved by immersing the medium in a suitable liquid during the recording process. For the purposes of illustration only, an acrylamide-based support medium can be contracted using a solution of NaNO₃ or ethanol. In this case, the replay wavelength and sensitivity of the resulting sensor may be accurately controlled by controlling the concentration of the solution.

Specific embodiments of the present invention will now be described by way of example with reference to the drawings, in which:

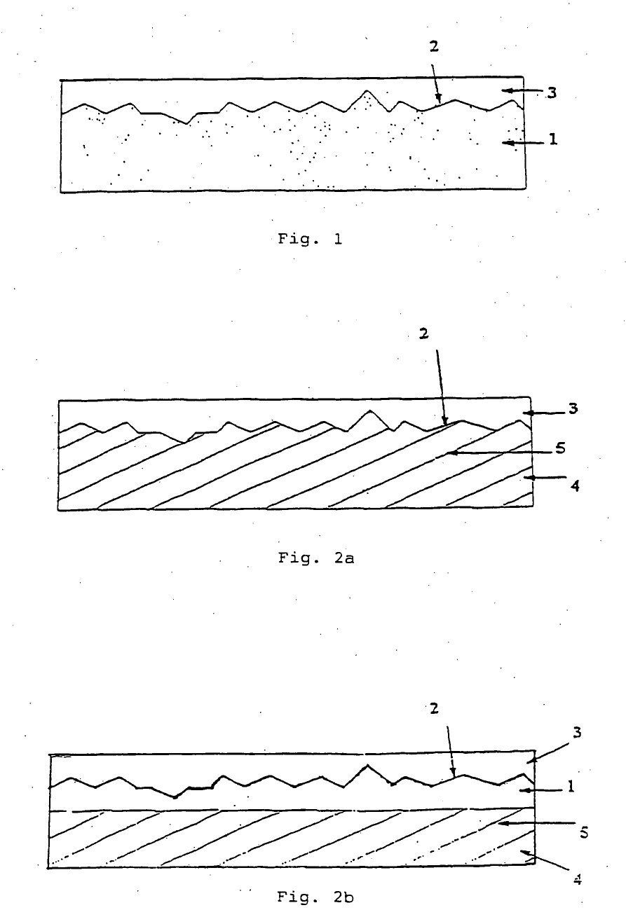

FIG. 1 shows a sectional schematic of a device according to a first embodiment of the present invention incorporating covert images;

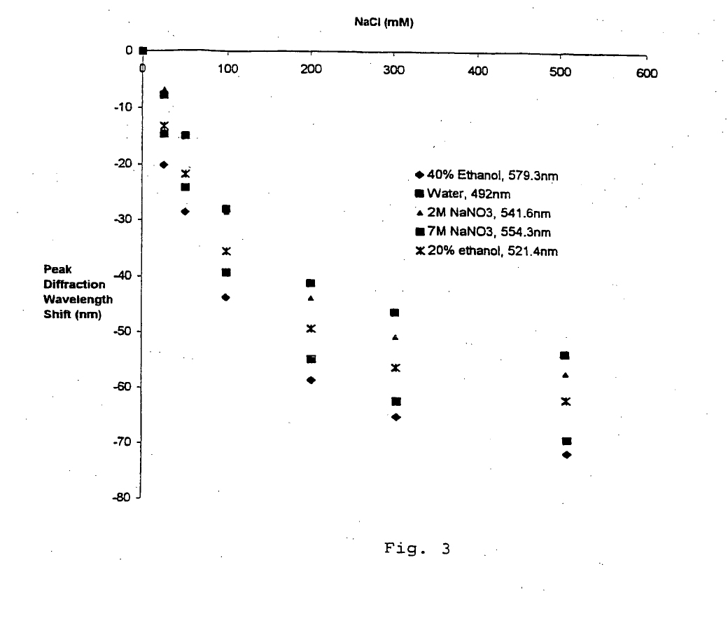

FIG. 2 shows sectional schematics of devices according to further embodiments of the present invention incorporating both overt and covert images; and

FIG. 3 shows results obtained in practice of the invention.

A first embodiment of the invention is illustrated in FIG. 1 which shows in sectional schematic a holographic device which has one or more images which are invisible under normal conditions and are therefore described as covert. The hologram is carried by a material 1 with an embossed surface 2 which is reflective when there is a difference in refractive index between the material 1 and its immediate environment. For viewing the image the immediate environment may for example be air. The holographic image is rendered invisible during a manufacturing process by coating, on the embossed surface, a layer of material 3 which has a refractive index similar to that of the embossed material 1. The principal feature of the embodiment is that the added layer 3 is made of a material which is stable under normal environmental conditions but is susceptible to having its refractive index altered or alternatively, to degradation and subsequent removal under the action of one or more specific chemicals, including biochemicals or solubilising agents. After the refractive index of this layer 3 has been altered, or the layer removed, the holographic image becomes visible.

The purpose of such a chemically-specific optical holographic device in the area of product security is provision of a restricted means of authenticating products which, for purposes of maintaining a brand image or otherwise, should not have an obvious mark, the device being substantially transparent.

Another preferred embodiment of the invention is illustrated in FIG. 2a which shows in sectional schematic a holographic device which has a group of one or more images which are visible under normal conditions and are therefore described as overt and also has a second group of one or more images which are invisible under normal conditions and are therefore described as covert. The overt holograms in this case are carried in a volume distribution of complex refractive index 5 formed by silver, silver salt, cross-linked polymer, photopolymer or other method of creating a volume hologram supported in an appropriate matrix. The second group of holograms is carried by a reflective embossed surface 2. This surface 2 may be that of the material which carries the first, overt, volume holograms or it may be that of another material 1 applied as a layer onto the first material as shown in FIG. 2b. Members of the second group of images are rendered covert by making them to be invisible during a manufacturing process by coating, on the embossed surface 2, a layer of material 3 which has a refractive index similar to that of the embossed material 1. The principal feature of the embodiment is that the added layer 3 is made of a material which is stable under normal environmental conditions but is susceptible to having its refractive index altered or, alternatively, to degradation and subsequent removal under the action of one or more specific chemicals. After such alteration or removal of this layer 3, the second group of images becomes visible. The purpose of this chemically-specific optical holographic device in the area of product security is provision of a restricted means of authenticating products which, for purposes of maintaining a brand image or otherwise, should have an obvious mark and also have the means to test for authenticity.

One application of any of the embodiments of the invention described above may be as a transparent label which is attached to a bottle of an alcoholic beverage with no apparent image and acting as a product authentication device which would need to be included by counterfeiters if they were to replicate the product packaging. In one case, the overlayer (the layer 3) would remain in place until its removal by a specific chemical mixture applied by a person employed to investigate the distribution of counterfeit products. The image revealed by such an operation can be proprietary to the brand owner of the product and therefore act as a further security device.

The following Examples illustrate the invention.

### EXAMPLE 1

### An Enzyme-Interrogated Embossed Label

One example of the device which is a subject of this invention uses a visible hologram which is a surface-embossed holographic grating impressed into a clear plastic such as polyester or polyvinyl chloride. As a result of constructive interference and Bragg reflection, a distinctive colour is observed from such a surface when it is illuminated with broad-band light. In this example, the colour may be in the mauve region of the spectrum. In order to make the colour disappear, a layer of gelatin is coated onto the embossed surface. The characteristics of the resulting device are that the reflected colour is in the visible region while the coating is saturated with water, which alters the refractive index of the gelatin, but when the coating dries out the entire film is transparent because the refractive index of the gelatin then matches that of the clear plastic beneath. This particular (gelatin) film can be removed by washing in hot water or, alternatively, by applying a proteolytic enzyme such as trypsin to dissolve the film. This approach can be extended to a wide range of other enzymes or mixtures of enzymes if the gelatin overlayer is replaced by one made from one or more different polymer materials which carry, in part or in whole, one or more components which are cleavable by a specific enzyme or group of specific enzymes. A particular example of a substrate is starch, which would be removed by the action of the enzyme amylase.

### EXAMPLE 2

### A Solvent-Interrogated Embossed Label

Another example of the device is similar to Example 1 but instead of the overlayer including enzyme substrates it is formed from a polymer or mix of polymers which are soluble, swellable or contractable in specific solvents. Changing the thickness changes the refractive index by virtue of both density change and addition of a solvent to the structure. One method which may be employed to coat the relief pattern is the solvent cast method, although this is not exclusive. For example, a layer of cellulose acetate can be solvent cast in acetone and the device interrogated by dissolving off the cellulose acetate layer in acetone.

### EXAMPLE 3

### An Embossed Label Integrated with an Overt Volume Hologram

Another example of the device is of the type previously described as Example 1 or 2 but with the addition of an underlayer comprising a volume hologram which provides an always visible (overt) image.

### EXAMPLE 4

A holographic support medium was formed by copolymerising 60 mol % acrylamide, 30 mol % methacrylamide, 5 mol % methylenebisacrylamide (a cross-linker) and 5 mol % 2-acrylamido-2-methyl-1-propanesulphonic acid. Silver halide was then immobilised within the medium. The medium was then immersed in water and a holographic image recorded. Four more sensors were formed in this way, each formed using one of the following solutions in place of water: 2M NaNO₃, 20% (v/v) ethanol, 7M NaNO₃ and 40% (v/v) ethanol (ordered in terms of their increasing contracting effect on the support medium). The resulting sensors were tested for their response to sodium chloride solutions of varying ionic strengths.

FIG. 3 shows the peak diffraction wavelength shift of each sensor for a given ionic strength. The shift in wavelength (i.e. the sensitivity) was greatest for the sensor obtained by recording the hologram in a support medium immersed in 40% (v/v) ethanol, i.e. the liquid which caused the greatest contraction of the support medium.

### EXAMPLE 5

A sample hologram was made using a single continuous wave laswer working at 633 nm. The recording material was gelatine and different sections of the polymer were pre-soaked in different solutions to produce various colours. A green section was the result of a pre-soak in 5% diethylene glycol and 10% triethanolamine in water, a blue section was due to a pre-soak in 10% diethylene glycol and 5% triethanolamine in water, a red-orange section had not been pre-soaked at all. This 3-colour hologram would be impossible to forge with a single laser. Mixing the pre-soak mixtures to form a gradient with different diethylene glycol and triethariolamine concentrations produce a gradient of colours across the holograms which would be impossible to forge.

I claim:

1. A holographic or diffraction device responsive to interrogation, the device comprising an image-former and an image-concealer; wherein the image-former is adapted such that light reflected from or transmitted through it forms at last one image; wherein the image-concealer acts to attenuate the image; and wherein the attenuation of the image by the image-concealer is alterable responsive to interrogation.

2. The device according to claim 1, wherein the image-concealer is responsive to interrogation using a chemical reagent which acts specifically on the image concealed.

3. The device according to claim 1, wherein the image-former comprises a relief surface such that when light reflects from the relief surface, the reflected light forms the image.

4. The device according to claim 1, wherein the image-concealer comprises a covering material layer, the optical properties of which act to attenuate one or more images.

5. The device according to claim 1, wherein the image-concealer is responsive to interrogation by a chemical reagent which acts specifically thereon, thereby altering the attenuation of one or more images.

6. The device according to claim 5, wherein the optical properties of the image-concealer are alterable responsive to the chemical reagent.

7. The device according to claim 1, wherein the image-concealer or the covering material layer is partially or fully removable responsive to the action of the chemical reagent.

8. The device according to claim 7, wherein the image-concealer or the covering material layer is partially or fully soluble in the chemical reagent.

9. The device according to claim 1, wherein the image-concealer comprises a substrate of an enzyme.

10. The device according to claim 1, wherein the image-concealer is in contact with a relief surface of the image-former and has a refractive index similar to the refractive index of the relief surface of the image-former.

11. The device according to claim 10, wherein the image-concealer has the same refractive index as the relief surface of the image-former.

12. The device according to claim 1, wherein the image-concealer is positioned such that light reflected from the image-former passes through the image concealed.

13. The device according to claim 1, wherein the image-concealer is positioned such that light incident on the image-former passes through the image concealed.

14. The device according to claim 1, wherein the absorption, scattering or reflection of light by the image-concealer acts to attenuate the image, and is alterable responsive to interrogation.

15. The device according to claim 13, wherein the relief surface is opaque.

16. The device according to claim 1, wherein the image-former comprises a volume distribution of complex index of refraction which forms one or more visible images in reflection or transmission.

17. The device according to claim 16, wherein the image-former comprises a plurality of layers, wherein the top layer comprises a relief surface and wherein an underlying layer comprises a volume distribution of complex index of refraction.

18. A holographic or diffraction device comprising a relief pattern in one surface of a first sheet of material such that reflected light forms an image, and an attenuator which comprises a covering material layer in contact with the relief pattern and attenuating the image, wherein the attenuator is susceptible to a chemical reagent thereby altering the attenuation of the image.

19. The device according to claim 18, wherein the relief pattern produces two or more images and treating the attenuation means with a reagent alters the attenuation of at least one of the images.

20. The device according to claim 18, wherein the first sheet of material has a refractive index which is similar to that of the covering material layer.

21. The device according to claim 20, wherein the first sheet of material has the same refractive index as the covering material layer.

22. The device according to claim 18, wherein the first sheet of material is not transparent.

23. The device according to claim 22, wherein the first sheet of material is opaque.

24. The device according to claim 18, wherein the covering material layer is not transparent.

25. The device according to claim 24, wherein the covering material layer is opaque.

26. The device according to claim 18, wherein the first sheet of material contains within its volume a distribution of complex index of refraction which forms a holographic image.

27. The device according to claim 18, further comprising a second sheet of material underlying the first sheet of material, the second sheet of material comprising a volume distribution of complex index of refraction which forms a visible image in reflection or transmission.

28. The device according to claim 18, wherein the chemical reagent comprises an enzyme and the attenuating means comprises one or more substrates to the enzyme, the attenuation being altered responsive to the action of the enzyme on the substrate.

29. The device according to claim 18, wherein the chemical reagent comprises a solvent and the attenuating means comprises a material which can be dissolved by the solvent, thereby altering the attenuation.

30. The device according to claim 18, wherein the attenuating means hides the image until it is acted on by the specific chemical reagent.

31. An article comprising a device attached thereto or incorporated therein wherein said device is:
a holographic or diffraction device responsive to interrogation, the device comprising an image-former and an image-concealer; wherein the image-former is adapted such that light reflected from or transmitted through it forms at last one image; wherein the image-concealer acts to attenuate the image; and wherein the attenuation of the image by the image-concealer is alterable responsive to interrogation; or
a holographic or diffraction device comprising a relief pattern in one surface of a first sheet of material such that reflected light forms an image, and an attenuator which comprises a covering material layer in contact with the relief pattern and attenuating the image, wherein the attenuator is susceptible to a chemical reagent thereby altering the attenuation of the image.

32. The article according to claim 31, which is a transaction card, banknote, passport, identification card, smart card, driving license, share certificate, bond, cheque, cheque card, tax banderole, gift voucher, postage stamp, rail or air ticket, telephone card, lottery card, event ticket, credit or debit card, business card, or an item used in consumer, brand or product protection for the purpose of distinguishing genuine products from counterfeit products or identifying stolen products.

33. The article according to claim 31, which is an item of intelligent packaging.

34. The article according to claim 31, which is an industrial or handicraft item comprising a decorative element, selected from items of jewelry, items of clothing, fabric, furniture, toys, gifts, household items, architecture, art, stationery and sporting goods.

35. The article according to claim 31, which is a product or device for use in agricultural studies, environmental studies, human or veterinary prognostics, theranostics, diagnostics, therapy or chemical analysis.

36. The article according to claim 35, which is a test strip, chip, cartridge, swab, tube, pipette, contact lens, sub-conjuctival implant, sub-dermal implant, breathalyzer, catheter or a fluid sampling or analysis device.

37. A transferable holographic film comprising a device wherein said device is:
a holographic or diffraction device responsive to interrogation, the device comprising an image-former and an image-concealer; wherein the image-former is adapted such that light reflected from or transmitted through it forms at last one image; wherein the image-concealer acts to attenuate the image; and wherein the attenuation of the image by the image-concealer is alterable responsive to interrogation; or
a holographic or diffraction device comprising a relief pattern in one surface of a first sheet of material such that reflected light forms an image, and an attenuator which comprises a covering material layer in contact with the relief pattern and attenuating the image, wherein the attenuator is susceptible to a chemical reagent thereby altering the attenuation of the image.

38. The film according to claim 37, which is present on a hot stamping tape.

39. A method of enhancing the security of an article, which comprises transferring onto the article, from a transferable holographic film, a device wherein said device is:
a holographic or diffraction device responsive to interrogation, the device comprising an image-former and an image-concealer; wherein the image-former is adapted such that light reflected from or transmitted through it forms at last one image; wherein the image-concealer acts to attenuate the image; and wherein the attenuation of the image by the image-concealer is alterable responsive to interrogation; or
a holographic or diffraction device comprising a relief pattern in one surface of a first sheet of material such that reflected light forms an image, and an attenuator which comprises a covering material layer in contact with the relief pattern and attenuating the image, wherein the attenuator is susceptible to a chemical reagent thereby altering the attenuation of the image.

40. A method selected from the following:
a) a method of verifying the authenticity of a holographic or diffraction device, the device providing a holographic or diffraction image which changes in response to interrogating by a specific interrogation means, the method comprising the steps of:
applying the specific interrogation means to the device;
viewing the image; and
establishing whether the resulting image is consistent with an authentic device;
b) a method of verifying the authenticity of a product, the product having a holographic or diffraction device thereon, the device providing a holographic or diffraction image which changes in response to interrogation by a specific interrogation means, the method comprising the steps of:
applying the specific interrogation means to the device;
viewing the image; and
establishing whether the resulting image is consistent with a device previously applied to the authentic product; and
c) a method for concealing or revealing a holographic or diffraction image, comprising the steps of:
applying an image-concealer to attenuate the holographic or diffraction image formed by an image-former; and
interrogating the image-concealer using an interrogation means to vary the attenuation of the image and thereby conceal or reveal the image.
